(19) United States
(12) Patent Application Publication
(10) Pub. No.: US 2004/0105116 A1
(43) Pub. Date: Jun. 3, 2004

(54) Method and apparatus for informing print error of a wireless printer

(75) Inventor: Jin-hyung Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Kyungki-do (KR)

(21) Appl. No.: 10/645,479

(22) Filed: Aug. 22, 2003

(30) Foreign Application Priority Data
Sep. 6, 2002 (KR) 2002-53816

(51) Int. Cl. G06F 15/00; G06F 3/12; G06F 11/30; G06F 13/00; H04B 17/00

(52) U.S. Cl. 358/1.14; 358/1.15; 710/15; 455/67.11

(57) ABSTRACT

A method, an apparatus, and a machine-readable medium for informing a user about a print error of a wireless printer in a wireless network.

### CROSS-REFERENCE TO RELATED APPLICATIONS

This application claims the priority of Korean Patent Application No. 2002-53816, filed on Sep. 6, 2002, in the Korean Intellectual Property Office, the disclosure of which is incorporated herein in its entirety by reference.

### BACKGROUND OF THE INVENTION

1. Field of the Invention

The present invention relates to wireless printing using a wireless printer server, and, more particularly, to a method and an apparatus for informing a user about a print error of a wireless printer in a wireless network.

2. Description of the Related Art

Unlike wired communications, which use physical media such as various types of cables, examples of conventional wireless communications in which electric waves are transmitted through air include wireless local area networks (wireless LANs), Blue Tooth wireless devices, and infrared data association (IrDA) devices. More specifically, a wireless LAN is formed by two different methods. First, a network is set using a plurality of computers and peripheral devices having wireless LAN cards. Second, a network is set using an access point with a wired LAN.

Furthermore, a printing operation can be performed wirelessly by connecting wireless printer servers to the printers. Here, a wireless printer server having a network interface card may be embedded in a printer, or the wireless printer server may be located outside the printer using a printer cable.

However, the conventional wireless printing method does not include a function of outputting print error information due to communication errors during the printing operation, in which data to be printed are wirelessly received.

### SUMMARY OF THE INVENTION

Accordingly, it is an aspect of the present invention to provide a method of informing a user about a print error of a wireless printer due to communication errors during a wireless printing operation.

It is another aspect of the present invention to provide an apparatus for informing a user about a print error of a wireless printer, the apparatus using the above method.

Additional aspects and/or advantages of the present invention will be set forth in part in the description that follows, and, in part, will be obvious from the description, or may be learned by practicing the present invention.

According to an aspect of the present invention, there is provided a method for informing a user about a print error of a printer that performs a wireless printing operation using a wireless printer server. The method comprises determining whether data to be printed are not received by the wireless printer server for more than a predetermined period during the wireless printing operation, requesting and receiving wireless communication information on the wireless printer server upon determining that the data to be printed is not received by the wireless printer server for more than the predetermined period, determining whether a link state or a link quality of a wireless communication is good by analyzing the received wireless communication information, generating print error information regarding the communication between the wireless printer server and a host when the link state or the link quality of the wireless communication is bad, and reporting the print error information to the user.

According to another aspect of the present invention, there is provided an apparatus for informing a user about a print error of a printer that performs a wireless printing operation using a wireless printer server. The apparatus includes a data receiving detection unit, which detects whether data to be printed are not received by the wireless printer server for more than a predetermined period during the wireless printing operation and outputs a detection result, a communication information request unit, which requests the wireless communication information on the wireless printer server in response to the detection result and outputs a requested result, a communication information analysis unit, which analyzes a link state or a link quality of the wireless communication by receiving the wireless communication information from the wireless printer server and outputs an analysis result, an error information generation unit, which generates print error information based on the analysis result and outputs the print error information, and an error information informing unit, which reports the user about the print error information.

### BRIEF DESCRIPTION OF THE DRAWINGS

These and/or other aspects and/or advantages of the present invention will become apparent and more readily appreciated from the following description of the preferred embodiments, taken in conjunction with the accompanying drawings of which:

FIG. 1 is a flowchart for explaining a method for informing a user about a print error of a wireless printer, according to the present invention;

FIG. 2 is a flowchart for explaining operation 14 of FIG. 1, according to an embodiment of the present invention;

FIG. 3 is a block diagram illustrating an apparatus for informing a user about a print error of a wireless printer, according to the present invention; and

FIG. 4 is a block diagram illustrating a communication information analysis unit of FIG. 3, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

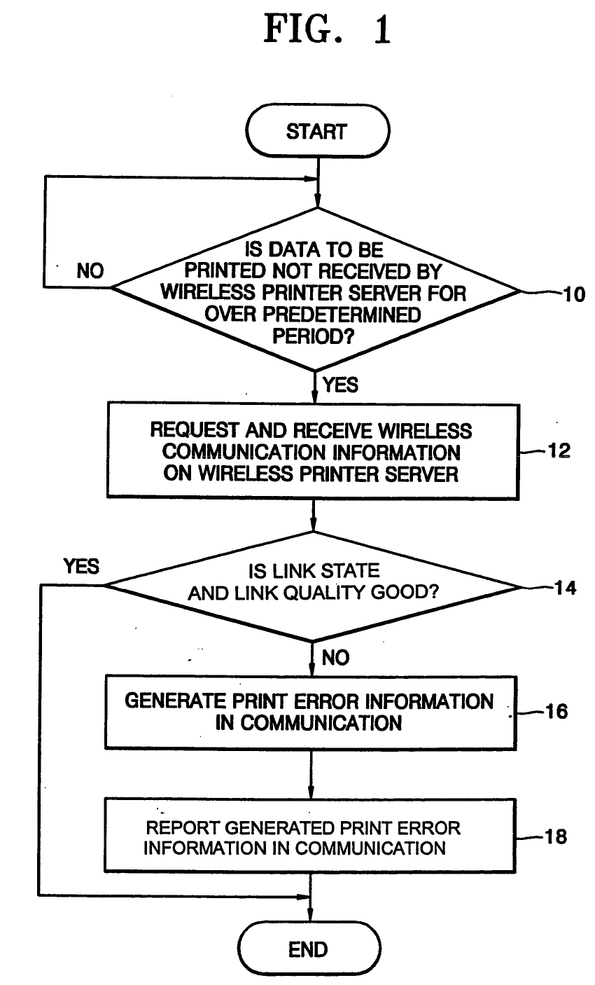

FIG. 1 is a flowchart for explaining a method of informing a user about a print error of a wireless printer. Generally, the method includes determining whether data to be printed are not received for more than a predetermined period, and generating and outputting print error information regarding the communication between a wireless printer server and a computer.

Referring to FIG. 1, it is determined whether the data to be printed are not received by the wireless printer server for over a predetermined period during a wireless printing operation, in operation 10. When it is determined that the data to be printed are received by the wireless printer server within the predetermined period during the wireless printing operation, operation 10 is repeated.

When it is determined that the data to be printed is not received by the wireless printer server for more than the predetermined period, wireless communication information on the wireless printer server is requested and received, in operation 12. In an embodiment, the wireless communication information on the wireless printer server includes link on information and link quality information that indicate a current state of a wireless network. In addition, the wireless communication information on the wireless printer server may further include channel information, or the identification address and the Internet address of a host, which transfers the data to be printed.

After operation 12, the received wireless communication information is analyzed to determine whether the link state and the link quality of the wireless communication are good in operation 14. When it is determined that the link state and the link quality of the wireless communication are good, the output of the print error information is ended.

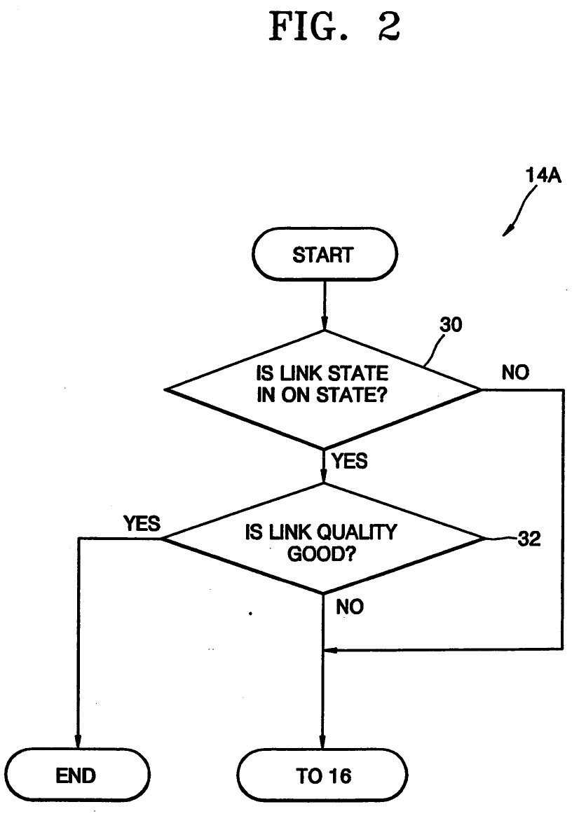

FIG. 2 is a flowchart for explaining an embodiment 14A of operation 14 of FIG. 1, according to the present invention. Referring to FIG. 2, embodiment 14A includes determining the link state and the link quality.

It is determined whether the link state of the wireless communication is in an on state in operation 30. Here, the link state denotes the connection state between the wireless printer server and the host, which transfers the data to be printed. When it is determined that the link state of the wireless communication is in an off state, operation 16 of FIG. 1 is performed.

However, when it is determined that the link state of the wireless communication is in an on state, it is determined whether the link quality is good to smoothly perform the wireless communication, in operation 32. Here, the link quality denotes the sensitivity of the communication between the wireless printer server and the host, which transfers the data to be printed. In addition, the sensitivity of the communication can be obtained by evaluating the sensitivity of a signal using a signal to noise (S/N) ratio or an error rate. The link quality can be determined with reference to the sensitivity of the communication, which is obtained via experiments. When it is determined that the link quality is not good enough to smoothly perform the wireless communication, operation 16 is performed.

Returning to FIG. 1, when it is determined that the link state or the link quality of the wireless communication is bad, the print error information is generated in operation 16. In an embodiment, the print error information includes the link state information and the link quality information on the wireless communication between the printer server and the host. In other words, the print error information may include information reporting whether the link state is in the on state or off state and information reporting whether the link quality is over or under a predetermined link quality. In addition, the print error information may further include the date and time when the error appeared, channel information, and the identification address and the Internet address of the host, which transfers the data to be printed.

After operation 16, the print error information is reported in operation 18. Here, the print error information may be reported by displaying the information on a display screen installed in the printer or by printing the information.

Hereafter, the structure and the operation of an apparatus for informing a user about a print error of a wireless printer, according to the present invention, will be described with reference to the drawings.

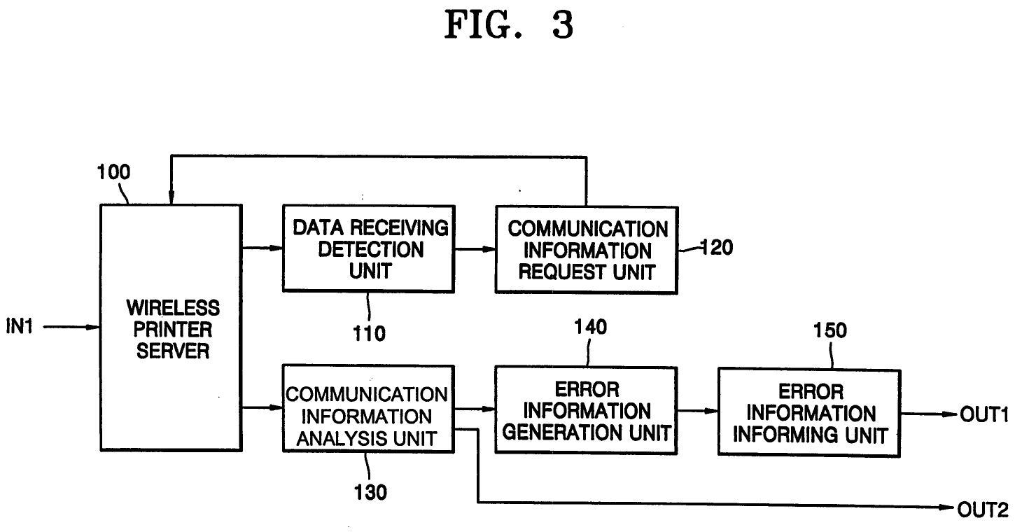

FIG. 3 is a block diagram illustrating the apparatus for reporting a print error of the wireless printer. Referring to FIG. 3, the apparatus includes a wireless printer server 100, a data receiving detection unit 110, a communication information request unit 120, a communication information analysis unit 130, an error information generation unit 140, and an error information informing unit 150.

In an embodiment, the wireless printer server 100 interfaces the wireless transfer of the data to be printed between the printer and the host in a wireless network environment. For example, the wireless printer server 100 receives the data to be printed from a computer via an input terminal IN1 and outputs the data to the data receiving detection unit 110. Here, the computer has a wireless LAN card, or a wired LAN card with an access point to perform the wireless network communication. In addition, the wireless printer server 100 outputs the wireless communication information to the communication information analysis unit 130 according to a request signal from the communication information request unit 120.

In order to perform operation 10, the data receiving detection unit 110 detects a state whether the wireless printer server 100 does not receive the data to be printed for over a predetermined period during a wireless printing operation, and outputs a detection result. In an embodiment, the data receiving detection unit 110 including a counter (not shown) which does not operate while the wireless printer server 100 receives the data to be printed having a predetermined size. When the wireless printer server 100 stops receiving the data to be printed before the printing operation is finished, the data receiving detection unit 110 starts to operate the counter. When the counter is operated for over a predetermined period, the data receiving detection unit 110 detects that the receiving of the data to be printed by the wireless printer server 100 is abnormally stopped and outputs the detection result to the communication information request unit 120.

In order to perform operation 12, the communication information request unit 120 requests the wireless communication information on the wireless printer server 100 in response to the detection result from the data receiving detection unit 110. For example, the communication information request unit 120 outputs a signal requesting the wireless communication information to the wireless printer server 100 in response to the detection result, which is transferred from the data receiving detection unit 110.

In order to perform operation 14, the communication information analysis unit 130 receives the requested wireless communication information from the wireless printer server 100 and analyzes the link state and the link quality of the communication to output an analysis result. In an embodiment, when the communication information analysis unit 130 determines that the link state or the link quality is bad based on the wireless communication information transferred from the wireless printer server 100, the communication information analysis unit 130 outputs the analysis result to the error information generation unit 140. In the other case, the communication information analysis unit 130 outputs the analysis result through an output terminal OUT2.

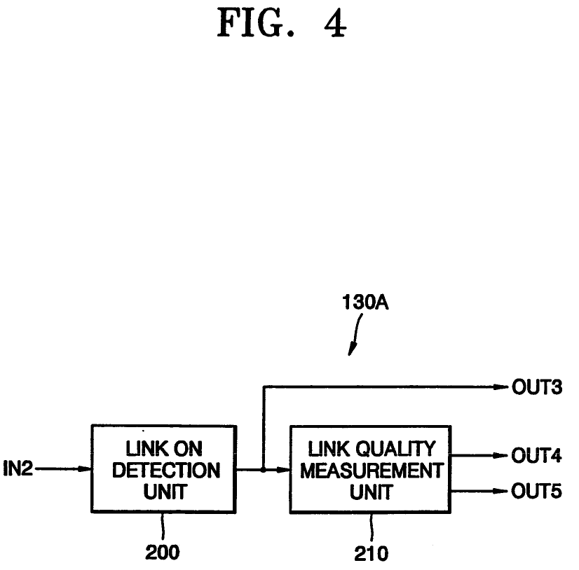

FIG. 4 is a block diagram illustrating an embodiment 130A of the communication information analysis unit 130 of FIG. 3, according to the present invention. Referring to FIG. 4, embodiment 130A includes a link on detection unit 200 and a link quality measurement unit 210.

In order to perform operation 30, the link on detection unit 200 detects whether the link state of the wireless communication is in an on state and outputs the detection result. For example, the link on detection unit 200 detects information on the link state, which is transferred from the wireless printer server 100 via an input terminal IN2, to determine whether the link state is in an on state. When the link state is in an on state, the link on detection unit 200 outputs the detection result to the link quality measurement unit 210. In the other case, the detection result is output to the error information generation unit 140 via an output terminal OUT3.

In order to perform operation 32, the link quality measurement unit 210 measures the link quality with the sensitivity of the communication and outputs the measurement result. In this case, when the link quality is over the sensitivity of the communication, which is experimentally obtained, it is determined that the link quality is excellent. In the other case, it is determined that the link quality is bad. In an embodiment, the link quality measurement unit 210 measures the link quality with a predetermined link quality in response to the detection result transferred from the link on detection unit 200. If the link quality is less than the predetermined link quality, the measurement result is output to the error information generation unit 140 via an output terminal OUT4. In the other case, the measurement result is output through an output terminal OUT5.

Returning to FIG. 3, in order to perform operation 16, the error information generation unit 140 generates the print error information based on the analysis result and outputs the generated print error information. Here, the print error information generated by the error information generation unit 140 includes the link state information and the link quality information which are generated based on the detection result from the link on detection unit 200 and the measurement result from the link quality measurement unit 210.

In an embodiment, the print error information generated by the error information generation unit 140 further includes the date and time when the error appeared, channel information, and the identification address and the Internet address of the host, which transfers the data to be printed. The error information generation unit 140 outputs the print error information to the error information informing unit 150.

In order to perform operation 18, the error information informing unit 150 reports the print error information. In an embodiment, the error information informing unit 150 displays the print error information on a display screen (not shown) of the printer or prints the print error information using a data printing unit (not shown). In other words, the error information informing unit 150 outputs a signal for displaying or printing the print error information, which is transferred from the error information generation unit 140 via an output terminal OUT1.

A print error due to communication errors between a wireless printer server and a host computer can be promptly corrected using the method and the apparatus of the present invention.

The hardware included in the system may include memories, processors, and/or Application Specific Integrated Circuits (“ASICs”). Such memory may include a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

While this invention has been particularly shown and described with reference to embodiments thereof, it will be understood by those skilled in the art that various changes in form and details may be made therein without departing from the spirit and scope of the present invention as defined by the appended claims.

What is claimed is:

1. A method of informing a user about a print error of a printer that performs a wireless printing operation using a wireless printer server, comprising:
(a) determining whether data to be printed are not received by the wireless printer server for more than a predetermined period during the wireless printing operation;
(b) requesting and receiving wireless communication information on the wireless printer server upon determining that the data to be printed are not received by the wireless printer server for more than the predetermined period;
(c) determining whether a link state or a link quality of a wireless communication is good by analyzing the received wireless communication information;
(d) generating print error information regarding the communication between the wireless printer server and a host when the link state or the link quality of the wireless communication is bad; and
(e) reporting the print error information to the user.

2. The method of claim 1, wherein (c) comprises:
(c1) determining whether the link state of the wireless communication is in an on state after (b); and
(c2) determining whether the link quality is in good condition to smoothly perform the wireless communication when the link state of the wireless communication is in the on state,
wherein if the link state of the wireless communication is in an off state in (c1) or the link quality is in a bad condition to smoothly perform the wireless communication in (c2), (d) is performed.

3. The method of claim 1, wherein the link state information and the link quality information on the wireless communication are generated as the print error information in (d).

4. The method of claim 3, wherein date and time when the print error appeared, channel information, or identification address and Internet address of the host, which transfers the data to be printed, are further generated as the print error information in (d).

5. The method of claim 1, wherein the print error information is displayed on a display screen of the printer or is printed in (e).

6. An apparatus for informing a user about a print error of a printer that performs a wireless printing operation using a wireless printer server, the apparatus comprising:
a data receiving detection unit to detect whether data to be printed are not received by the wireless printer server for more than a predetermined period during the wireless printing operation and to output a detection result;
a communication information request unit to request the wireless communication information on the wireless printer server in response to the detection result and to output a requested result;
a communication information analysis unit to analyze a link state or a link quality of the wireless communication by receiving the wireless communication information from the wireless printer server and to output an analysis result;
an error information generation unit to generate print error information based on the analysis result and to output the print error information; and
an error information informing unit to report the print error information to the user.

7. The apparatus of claim 6, wherein the communication information analysis unit comprises:
a link on detection unit to detect whether the link state of the wireless communication is in an on state and to output a detection result; and
a link quality measurement unit to measure the link quality with a sensitivity of communication between the wireless server printer and a host in response to the detection result and to output a measurement result,
wherein the error information generation unit generates the print error information based on the detection result or the measurement result.

8. The apparatus of claim 6, wherein the error information generation unit generates the link state information and the link quality information on the wireless communication as the print error information.

9. The apparatus of claim 8, wherein the error information generation unit further generates a print date and time when the print error appeared, channel information, or identification address and Internet address of the host, which transfers the data to be printed.

10. The apparatus of claim 6, wherein the error information informing unit displays the print error information on a display screen of the printer or prints the print error information.

11. A method, comprising:
determining, during a printing operation, whether data to be printed on a wireless network printer is not received for more than a predetermined period of time; and
generating and reporting print error information regarding a communication between a wireless network printer server and a computer when data is not received for more than the predetermined period of time.

12. The method of claim 11, further comprising:
determining whether a link quality and a link state of the communication are both good,
wherein the print error information is not generated and transmitted when the link quality and the link state are both good.

13. The method of claim 12, wherein the link quality denotes a sensitivity of the communication, which can be measured using a signal-to-noise (S/N) ratio or an error rate.

14. A machine-readable medium that provides instructions, which, when executed by a machine, cause the machine to perform operations comprising:
determining, during a printing operation, whether data to be printed on a wireless network printer is not received for more than a predetermined period of time; and
generating and reporting print error information regarding a communication between a wireless network printer server and a computer when data is not received for more than the predetermined period of time.

15. The machine-readable medium of claim 14, wherein the instructions cause the machine to perform operations further comprising:
determining whether a link quality and a link state of the communication are both good,
wherein the print error information is not generated and transmitted when the link quality and the link state are both good.

16. The machine-readable medium of claim 15, wherein the link quality denotes a sensitivity of the communication, which can be measured using a signal-to-noise (S/N) ratio or an error rate.
